(19) United States
(12) Patent Application Publication
(10) Pub. No.: US 2014/0071040 A1
(43) Pub. Date: Mar. 13, 2014

(54) System and method for planning or organizing items in a list using a device that supports handwritten input

(71) Applicant: Plackal Techno Systems Pvt. Ltd., Bangalore (IN)

(72) Inventor: John Paul, Bangalore (IN)

(73) Assignee: Plackal Techno Systems Pvt. Ltd., Bangalore (IN)

(21) Appl. No.: 13/972,209

(22) Filed: Aug. 21, 2013

(30) Foreign Application Priority Data
Sep. 13, 2012 (IN) 3798/CHE/2012

(51) Int. Cl. G06F 3/01

(52) U.S. Cl. CPC G06F 3/01
USPC 345/156

(57) ABSTRACT

A method for generating a list of images associated with items for planning or organizing the items on a device configured for receiving handwritten input is provided. The method includes (i) processing a first handwritten input including a first content associated with a first item, (ii) generating a first image that includes the first content associated with the first item, (iii) processing a second handwritten input including a second content associated with a second item, (iv) generating a second image that includes the second content associated with the second item, (v) generating a list that includes the first image, and the second image, and (vi) displaying the list that includes the first image and the second image. The first image and the second image are stored in a database.

### CROSS-REFERENCE TO RELATED APPLICATIONS

This application claims priority to Indian patent application no. 3798/CHE/2012 filed on Sep. 13, 2012, the complete disclosure of which, in its entirety, is herein incorporated by reference.

### BACKGROUND

1. Technical Field

The embodiments herein generally relate to planning and managing one or more items of a list, and, more particularly, to generating, organizing and/or communicating a list of images that include content associated with one or more items based on a user device that supports handwritten inputs.

2. Description of the Related Art

Planning and managing items in an organized way (e.g., as a list) helps users to achieve their goals. Typically available tools help users to manage their to do lists, and projects electronically in an efficient manner. Such typical tools are designed to be executed on devices such as desktop PCs, laptops, etc. The devices typically receive inputs related to items through a keyboard in a form of text. The inputs include text that are stored, and are modified when users edit the text using the keyboard. Storing items in a form of text is preferred in order to process the text further, edit it, or interpret it. The focus of typical tools is to include comprehensive and complex functionalities related to item (e.g., task) and project management such as classification, mechanism, calendaring, notifications, assigning, configurability, reporting etc that allow for management of more complex projects and a large number of items that need to be monitored and tracked.

In addition to desktop PCs and laptops, devices such as tablets and smart phones are increasingly popular for personal use as well as business use. These devices may use touch screen technology to implement an interface that processes input by hand or by an input device such as a stylus. The stylus is a small pen-shaped instrument that is used to input commands to a computer screen, a mobile device or a graphics tablet. With touch screen devices, a user places a stylus on surface of a screen to draw or make selections by tapping the stylus on the screen. A device designed to receive input from a stylus is more easy to use for users who find it more intuitive and convenient to use a pen and write as they would write on paper, as compared to a keyboard.

Smart phones and tablets that accept stylus based input are available in the market, however, devices featuring stylus input have not been adopted as widely, partly because there are not many software applications that are customized to stylus based devices that utilize their capabilities for an intuitive interface effectively. For example, a software application that is more complex and less intuitive or less easy to use would not be suited for a device that has a more intuitive interface. Typically, there are some software applications for item management that can be executed on a smart phone or a tablet, including stylus based inputs, however the inputs relating to items are stored as text, in a same manner as if it were received from any other input source such as the keyboard. Such applications do not effectively harness capabilities of a stylus based device that enables usage of functionalities with ease.

### SUMMARY

In view of the foregoing, an embodiment herein provides a method for generating a list of images associated with items for planning or organizing the items on a device configured for receiving handwritten input is provided. The method includes: (i) processing, by a handwritten input processing unit, a first handwritten input including a first content associated with a first item, (ii) generating, by a processor, a first image that includes the first content associated with the first item, (iii) processing, by the handwritten input processing unit, a second handwritten input including a second content associated with a second item, (iv) generating, by the processor, a second image that includes the second content associated with the second item, (v) generating, by the processor, a list that includes the first image and the second image, and (vi) displaying the list that includes the first image and the second image. The first image and the second image are stored in a database.

A third handwritten input may be processed to obtain a metadata associated with the first image that corresponds to the first item, and a fourth handwritten input may be processed to obtain a metadata associated with the second image that corresponds to the second item of the list. The metadata may include at least one of (a) a schedule, (b) a status, (c) a priority, and (d) a category. A list of prioritized images may be generated by (a) processing the third handwritten input that may include an indication to drag and drop the first image associated with the first item to a position at the list, or (b) processing the fourth handwritten input that includes an indication to drag and drop the second image associated with the second item to a position at the list. The third handwritten input may include an indication to strike the first image associated with the first item may be processed to remove the first image from the list or reorder the first image to indicate a low priority in the list, or the fourth handwritten input may include an indication to strike the second image associated with the second item from the list may be processed to remove the second image from the list or reorder the second image to indicate a low priority in the list.

The first image or the list may be displayed based on a schedule associated with the first item as a first alert, and a second image or the list may be displayed based on a schedule associated with the second item as a second alert. At least one of the first image and the second image may be updated based on a handwritten input when the first alert or the second alert is displayed. Images of the list may be filtered based on metadata associated with at least one image of the list to obtain a list of filtered images. The list of filtered image, and a metadata associated with at least one image of the list of filtered images may be communicated through a medium including an electronic mail. The list of filtered images and (ii) the metadata may be displayed on a message body of the electronic mail. The method may further include (i) processing a fifth handwritten input including at least one of: (a) additional content associated with (i) the first content that corresponds to the first image, or (ii) the second content that corresponds to the second image, and (b) an indication to remove a subset of content from (i) the first image, or (ii) the second image, and (ii) updating the first image or the second image based on at least one of (a) the additional content, and (b) the indication. A selection of a duration from an electronic calendar of the device may be processed. Images associated with a set of items that has scheduled to execute at the duration may be generated. The images associated with the set of items may be displayed.

In another aspect, a system for generating a list of images associated with items for planning or organizing the items on a device configured for receiving handwritten input is provided. The system includes (a) a memory unit that stores (i) a set of modules, and (ii) a database, (b) a display unit, (c) a handwritten input processing unit that processes handwritten inputs including at least one of (i) a touch on the display unit, and (ii) a gesture, and (d) a processor that executes the set of modules. The handwritten inputs associate with a) a first content associated with a first item, and b) a second content associated with a second item. The set of modules include (i) a list generating module including: (a) an image generating module, executed by the processor, that generates (i) a first image that includes the first content associated with the first item, and (ii) a second image that includes the second content associated with the second item. The list generating module, executed by the processor that generates a list that includes the first image and the second image. The set of modules further include (ii) a display module, executed by the processor that displays at the display unit the list including the first image and the second image. The first image that corresponds to the first item and the second image that corresponds to the second item of the list are stored in the database. A metadata module, executed by the processor, that may process (a) a third handwritten input to obtain a metadata associated with the first image that corresponds to the first item, and (b) a fourth handwritten input to obtain a metadata associated with the second image that corresponds to the second item of the list. The metadata may include at least one of (a) a schedule, (b) a status, (c) a priority, and (d) a category.

The metadata module may include a prioritizing module, executed by the processor, that may generate a list of prioritized images by (a) processing the third handwritten input that includes an indication to drag and drop the first image associated with the first item to a position at the list, or (b) by processing the fourth handwritten input that includes an indication to drag and drop the second image associated with the second item to a position at the list. The metadata module may further include a status obtaining module, executed by the processor, that (a) may process the third handwritten input includes an indication to strike the first image associated with the first item to remove the first image from the list or reorder the first image to indicate a low priority in the list, or (b) may process the fourth handwritten input includes an indication to strike the second image associated with the second item from the list to remove the second image from the list or reorder the second image to indicate a low priority in the list. The metadata module may further include a categorizing module, executed by the processor that may process a fifth handwritten input including content to generate a category. A third image that corresponds to a third item may be associated with the category.

An alert generating module executed by the processor that (i) may display (a) the first image or (b) the list based on a schedule associated with the first item as a first alert, and (ii) may display (a) a second image or (b) the list based on a schedule associated with the second item as a second alert. At least one of (a) the first image or (b) the second image may be updated based on a handwritten input when the first alert or the second alert is displayed. An image filtering module, executed by the processor, that may filter images of the list based on metadata associated with at least one image of the list to obtain a list of filtered images. A communicating module, executed by the processor, that may communicate (i) the list of filtered images, and (ii) a metadata associated with at least one image of the list of filtered images through a medium including an electronic mail. The list of filtered images and the metadata may be displayed on a message body of the electronic mail. A character recognizing module, executed by the processor, that (a) may recognize a numeral in (i) the first image or (ii) the second image, and (b) may generate (a) a call or (b) a message to a communication device associated with the numeral.

In yet another aspect, a device for generating a list of filtered images associated with items for planning or organizing the items on a device configured for receiving handwritten input is provided. The device includes (a) a memory unit that stores (i) a set of modules, and (ii) a database, (b) a display unit, (c) a handwritten input processing unit that processes handwritten inputs including at least one of (i) a touch on the display unit, and (ii) a gesture, and (d) a processor that executes the set of modules. The handwritten inputs associate with a) a first content associated with a first item, and b) a second content associated with a second item. The set of modules include (i) a list generating module including: (a) an image generating module, executed by the processor, that generates (i) a first image that includes the first content associated with the first item, and (ii) a second image that includes the second content associated with the second item. The list generating module, executed by the processor that generates a list that includes the first image and the second image. The set of modules further include (ii) a display module, executed by the processor that displays at the display unit the list including the first image and the second image, and (iii) an image filtering module, executed by the processor, that filters images of the list based on metadata associated with at least one image of the list to obtain a list of filtered images. The first image that corresponds to the first item and the second image that corresponds to the second item of the list are stored in the database.

A communicating module, executed by the processor, that may communicate (i) the list of filtered images and (ii) a metadata associated with at least one image of the list of filtered images through a medium including an electronic mail. The list of filtered images and the metadata may be displayed on a message body of the electronic mail.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user communicating to a user device that includes an item management tool to create a list of images associated with items by providing handwritten inputs according to one embodiment of the present disclosure.

FIG. 2 illustrates an exploded view of the item management tool of FIG. 1 according to one embodiment of the present disclosure.

FIG. 3 is a user interface view of the categorizing module of the item management tool of FIG. 1 for generating one or more categories associated with tasks according to one embodiment of the present disclosure.

FIG. 4 illustrates a user interface view for creating a list that includes one or more images associated with tasks to be completed by providing handwritten inputs using the input device on a touch sensitive display interface of the user device according to one embodiment of the present disclosure.

FIG. 5A and FIG. 5B illustrate a user interface view of the status obtaining module of the item management tool of FIG. 1 according to one embodiment of the present disclosure.

FIG. 6A and FIG. 6B illustrate a user interface view of the prioritizing module of the item management tool of FIG. 1 according to one embodiment of the present disclosure.

FIG. 7 illustrates a user interface view of the alert generating module of the item management tool of FIG. 1 for generating alerts according to one embodiment of the present disclosure.

FIG. 8 is a table view illustrating tasks associated with images of the list of FIG. 4, and metadata that correspond to each image of the list according to one embodiment of the present disclosure.

With respect to FIG. 8, FIG. 9 is a user interface view illustrates sharing the list of FIG. 4 based on metadata associated with one or more images of the list according to one embodiment of the present disclosure.

With reference to FIG. 8 and FIG. 9, FIG. 10A-D is user interface view that are displayed to one or more person when the user provides a handwritten input to select a share field for sharing the list of FIG. 4 through a medium of electronic mail according to one embodiment of the present disclosure.

FIG. 10E illustrates a user interface view that is displayed to the one or more users while communicating the list of FIG. 4 through an electronic mail according to one embodiment of the present disclosure.

FIG. 11 illustrates a user interface view that illustrates generating images associated with one or more tasks that have scheduled for a duration based on a selection of the duration from an electronic calendar according to one embodiment of the present disclosure.

FIG. 12 illustrates a process view of using the item management tool of FIG. 1 for creating back-up and synchronizing one or more tasks of the first category “office” on the item management server of FIG. 1 according to one embodiment of the present disclosure.

FIG. 13 illustrates an example of a list of items (a checklist) that includes one or more images associated with items for planning or organizing the items based on handwritten input according to one embodiment of the present disclosure.

FIG. 14 illustrates an another example of a list of items (a shopping list) that includes one or more images associated with items for planning or organizing the items based on handwritten input according to one embodiment of the present disclosure.

FIG. 15 is a flow diagram illustrating a method for generating a list of images associated with items for planning or organizing the items on the user device which is configured for receiving handwritten inputs according to one embodiment of the present disclosure.

FIG. 16 illustrates an exploded view of a receiver used in accordance with the embodiments herein; and

FIG. 17 illustrates a schematic diagram of a computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

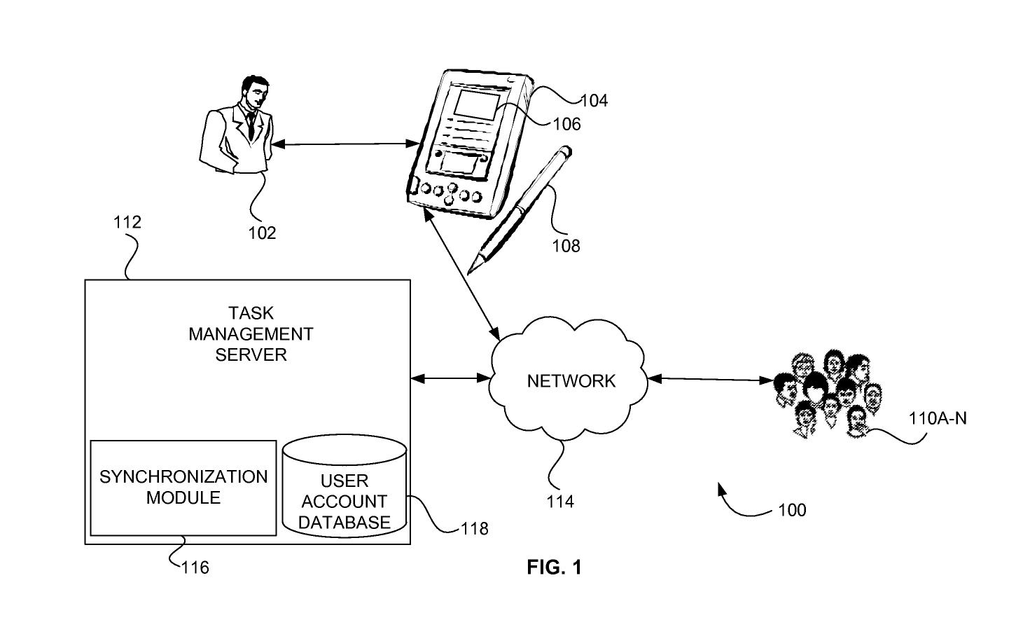

As mentioned, there remains a need for an item management tool that effectively harnesses capabilities of a stylus based device. The embodiments herein achieve this by providing the item management tool for generating, organizing and/or communicating a list of images that include content associated with one or more items based on a user device that supports handwritten input. Content associated with items are generated as handwritten inputs, and each image of the list of images is stored in a database. In one embodiment, the images appear the same way as it was written through the handwritten input. Referring now to the drawings, and more particularly to FIGS. 1 through 17, where similar reference characters denote corresponding features consistently throughout the figures, there are shown preferred embodiments.

FIG. 1 illustrates a system view 100 of a user 102 communicating to a user device 104 that includes an item management tool 106 to create a list of images associated with items by providing handwritten inputs according to one embodiment of the present disclosure. The user device 104 may be a smart phone, a tablet PC, or any other hand held device. The user device 104 includes a touch detecting unit (e.g., a touch sensitive display interface), and/or a gesture detecting unit for detecting one or more handwritten inputs. The user device 104 also includes a handwritten input processing unit (not shown in the FIG. 1) that processes one or more handwritten inputs including at least one of a) a touch on the touch sensitive display interface which is detected based on the touch detecting unit, or a gesture which is detected based on the gesture detecting unit. In one embodiment, the user device 104 that includes the touch sensitive display interface recognizes handwritten inputs from the user 102. For instance, the user 102 may provide a handwritten input that includes content associated with an item on the touch sensitive display interface of the user device 104. In another embodiment, the user device 104 includes the gesture detecting unit (e.g., a hardware component such as a camera, Infrared techniques, a software tool, etc) for detecting handwritten inputs such as the gesture that is associated with generating and/or managing one or more items of a list. The user device 104 may also include a touchpad (wired or wireless) for transmitting information (e.g., list of images that define items) from the user device 104 to a secondary display device.

The handwritten input may be provided using an input device 108, a gesture, and/or using other objects (e.g., a finger of the user 102). The input device 108 may be a stylus pen or a digital pen (e.g., a pen-like input device). The item management tool 106 processes the handwritten input, and generates an image that includes the content, and displays the image at the touch sensitive display interface of the user device 104 as an item.

Similarly, for one or more handwritten inputs that include content associated with one or more items, the item management tool 106 creates a list of images. In one embodiment, an image associated with each item of the one or more items is stored in a database (not shown in the FIG. 1). In one embodiment an image associated with an item appears a same way as it is written through a handwritten input. Further, the user 102 may communicate a list of images associated with items to one or more users 110A-N through medium including, but not limited to, a) social network, and/or b) an electronic mail.

The user device 104 communicates handwritten inputs to an item management server 112 through a network 114. The item management server 112 includes a synchronization module 116 and a user account database 118. The synchronization module 116 may create a back-up of items that are provided as handwritten inputs, synchronize updates on previously defined items, and stores metadata associated with items. The user 102 and the one or more users 110 A-N may create user accounts on the item management server 112. The user accounts that are created may be stored in the user account database 118.

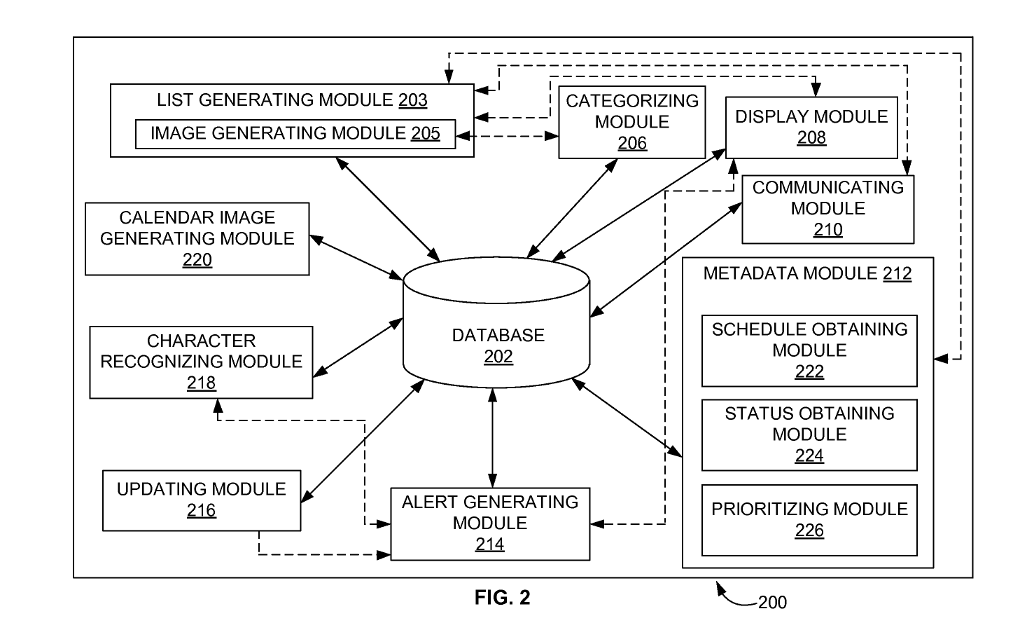

FIG. 2 illustrates an exploded view 200 of the item management tool 106 of FIG. 1 according to one embodiment of the present disclosure. The exploded view 200 of the item management tool 106 includes a database 202, a list generating module 203 that includes an image generating module 205, a categorizing module 206, a display module 208, a communicating module 210, a metadata module 212, an alert generating module 214, an updating module 216, a character recognizing module 218, a calendar image generating module 220, and an image filtering module 221 (not shown in the FIG). The database 202 stores images, metadata associated with one or more items, and any update on the images and the metadata.

When the user 102 provides one or more handwritten inputs that include content associated with generating one or more categories, and/or items using the user device 104, the handwritten input processing unit processes the one or more handwritten inputs. The one or more handwritten inputs may be provided using the input device 108. The image generating module 205 generates images that include content which are provided as the handwritten inputs. In one embodiment, an image and/or metadata associated with each item of a list of items are stored in the database 202.

The categorizing module 206 allows the user 102 to create one or more categories, and add one or more items to each category. For example, the user 102 creates a category ‘office’ using the categorizing module 206. The user 102 can create and/or add one or more items (e.g., tasks such as all hands meeting at 3 PM, a hiring review, and a vendor meeting) to the category ‘office’ using the handwritten input processing unit. The display module 208 displays categories, and items associated with each category to the user 102 as images.

The communicating module 210 allows the user 102 to communicate a list of images associated with items to one or more users through medium including, but not limited to, a) an electronic mail, and b) a social network. The user 102 may also communicate the list of images associated with items through offline communicating technologies such as Bluetooth, infrared, etc. In one embodiment, the list of images associated with items is displayed on a message body of an electronic mail, when the user 102 communicates the list of images through the electronic mail. However, the list of images can also be communicated as an attachment through the electronic mail.

The metadata module 212 processes a handwritten input from the user 102 to obtain a metadata associated with an item of the list of images, whereas each image corresponds to an item. The metadata associated with an item may include, but not limited to, i) a schedule, ii) a status, iii) a priority, iv) a category, and v) person information associated with the item. The metadata module 212 further includes a schedule obtaining module 222, a status obtaining module 224, a prioritizing module 226, and a category obtaining module 228 (not shown in the FIG. 2).

The schedule obtaining module 222 processes a handwritten input including an indication to obtain a schedule associated with an item. For example, when the item is a task, and a schedule associated with the task which indicates a duration in which the task is planned to execute is obtained based on a handwritten input. The user 102 may provide a handwritten input including an indication to select a duration (e.g., 8 AM, or 8 AM to 9 AM) from a digital time clock in order to schedule a task. The schedule obtaining module processes the handwritten input, and schedule the task for 8 AM.

The status obtaining module 224 processes a handwritten input including an indication to obtain a status of an item of a list. For example, when the item is a task, then a status associated with the task that indicates whether the task is completed or still pending is obtained. For example, once a task is completed, the user 102 may provide a handwritten input that includes an indication to strike an image associated with the task. The indication to strike the image associated with the task indicates that the task is completed. Also, the image of the task that is completed is represented in a manner such that it may differ from the tasks that are still pending. One such example to differentiate a completed task to a pending task is providing hatch lines on an image of the completed task, but not in an image of pending task. Further, the tasks that are yet to be completed may be placed ahead of tasks that have completed.

The prioritizing module 226 processes a handwritten input including an indication to obtain a priority of an item of a list. For example, when the item is a task, then a priority associated with the task which indicates an order of tasks to be executed is obtained. For example, a list of tasks includes a first task, a second, and a third task. When the second task is more priority than the first task and the third task, the user 102 may provide an indication to drag and drop a second image associated with the second task ahead of i) a first image associated with the first task, and ii) a third image associated with the third task.

The category obtaining module 228 processes a handwritten input includes an indication to add an image associated with an item to a category (e.g., a pre-defined category) of the item management tool 106. For example, when the user 102 provides a handwritten input includes an indication to add an image “all hands meeting at 4 PM” to a pre-defined category “office”, the category obtaining module 228 processes the handwritten input and adds the image “all hands meeting at 4 PM” to the pre-defined category “office”.

The alert generating module 214 generates an alert based on a schedule of an item (e.g., a task of a list). The display module 208 further displays a corresponding image (content as it was written) of the task at a pre-defined time as an alert. The updating module 216 updates images associated with tasks. The user 102 may edit an image including content associated with an item (e.g., a task) using the updating module 216 that processes a handwritten input including i) additional content associated with the item, and/or ii) an indication to remove a subset of content from the content associated with the item.

For example, the user 102 may intend to update an image ‘meeting at 4 PM’ to ‘meeting at 3 PM’. The updating module 216 processes a first handwritten input including an indication to remove a subset of content such as a numeral ‘4 from the content ‘meeting at 4 PM’. Further, the updating module processes a second handwritten input including additional content (e.g., a numeral ‘3’) to update the image ‘meeting at 4 PM’ to ‘meeting at 3 PM’. In one embodiment, when displaying an alert that includes an image associated with a task, the user 102 can update the image using the updating module 216.

The character recognizing module 218 recognizes one or more numerals that occur in an image/content associated with an item (e.g., a task), and provides an option to i) generate a call, and/or ii) generate a message to a communication device associated with the one or numerals. The character recognizing module 218 may identify the one or more numerals from the image/content using a natural language processing technique. The calendar image generating module 220 generates images associated with a set of items (e.g., a set of tasks) that has scheduled to execute at a duration upon selection of the duration from an electronic calendar. Further, the user 102 may apply themes for items, and such themes are pre-defined and stored in the database 202.

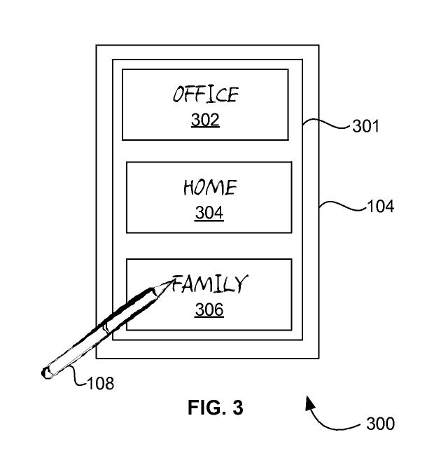

Embodiments herein below from FIG. 3 to FIG. 12 describe generating, organizing, planning, and sharing a list of items, whereas each item of the list defines a task. FIG. 3 is a user interface view 300 of the categorizing module 206 of the item management tool 106 of FIG. 1 for generating one or more categories 301 associated with tasks according to one embodiment of the present disclosure. The user 102 may provide handwritten inputs that include content associated with generating categories on a touch sensitive display interface of the user device 104. The categorizing module 206 processes the handwritten inputs, and creates the categories. For example, the user 102 provides handwritten inputs that may include content such as ‘office’, ‘home’, and ‘family’. The categorizing module 206 processes the handwritten inputs, and creates the one or more categories 301 including a first category ‘office’ 302, a second category ‘home’ 304, and a third category ‘family’ 306.

The user 102 can add more categories by providing associated content as handwritten inputs. The user 102 can also delete, and/or edit at least one category from the one or more categories 301. In one embodiment, the first category ‘office’ 302, the second category ‘home’ 304, and the third category ‘family’ 306 are displayed to the user 102 as it was written using the input device 108 on the touch sensitive display interface of the user device 104. The user 102 can also create, and add/associate images that correspond to tasks to be completed within each category. For example, for the first category ‘office’ 302, the user 102 may create one or more tasks (e.g., meeting at 3 PM), and the image generating module 205 generates an images that correspond to the task ‘meeting at 3 PM’.

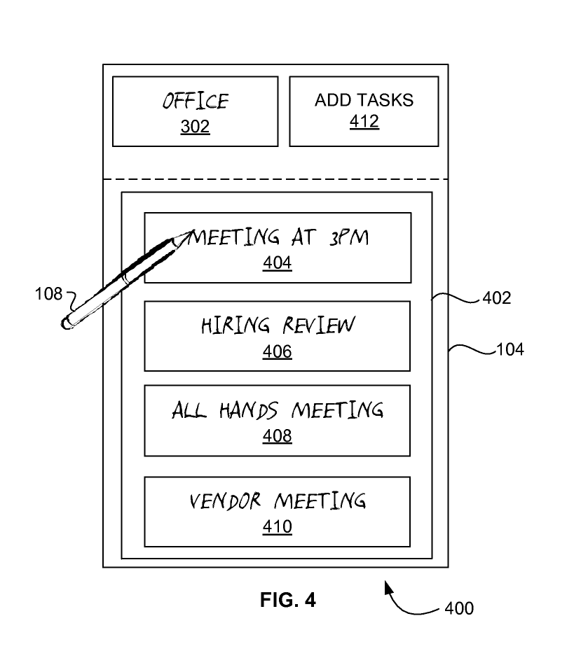

FIG. 4 illustrates a user interface view 400 for creating a list 402 that includes one or more images associated with tasks to be completed by providing handwritten inputs using the input device 108 on a touch sensitive display interface of the user device 104 according to one embodiment of the present disclosure. The user 102 can create one or more tasks to be completed on each category. For example, the user 102 may indicate to select the first category ‘office’ 302 of FIG. 3, and creates the list 402 as described below.

The user 102 provides a first handwritten input that may include a first content ‘meeting at 3 PM’ associated with a first task to be completed. The handwritten input processing unit processes the first handwritten input, and the image generating module 205 generates a first image that includes the first content ‘meeting at 3 PM’. The first image 404 includes content ‘meeting at 3 PM’ is displayed to the user 102 as it was written in the list 402.

Similarly, the handwritten input processing unit processes a second handwritten input that includes a second content ‘hiring review’, and the image generating module 205 generates a second image 406 that includes the second content ‘hiring review’ that corresponds to a second task. The second image 406 includes content ‘hiring review’ is displayed to the user 102 as it was written in the list 402. Similarly, a third image 408 includes content ‘all hands meeting’ associated with a third task, and a fourth image 410 includes content ‘vendor meeting’ associated with a fourth task are generated, and displayed in the list 402. Thus, the list 402 is created, and the display module 208 displays images associated with the first task, the second task, the third task, and the fourth task as the list 402. The user may add one or more tasks to the first category ‘office’ 302 using an ‘add tasks’ field 412. Similarly, the user may create list of images that include one or more tasks to be completed for the second category ‘home’ 304, and/or the third category ‘family’ 306.

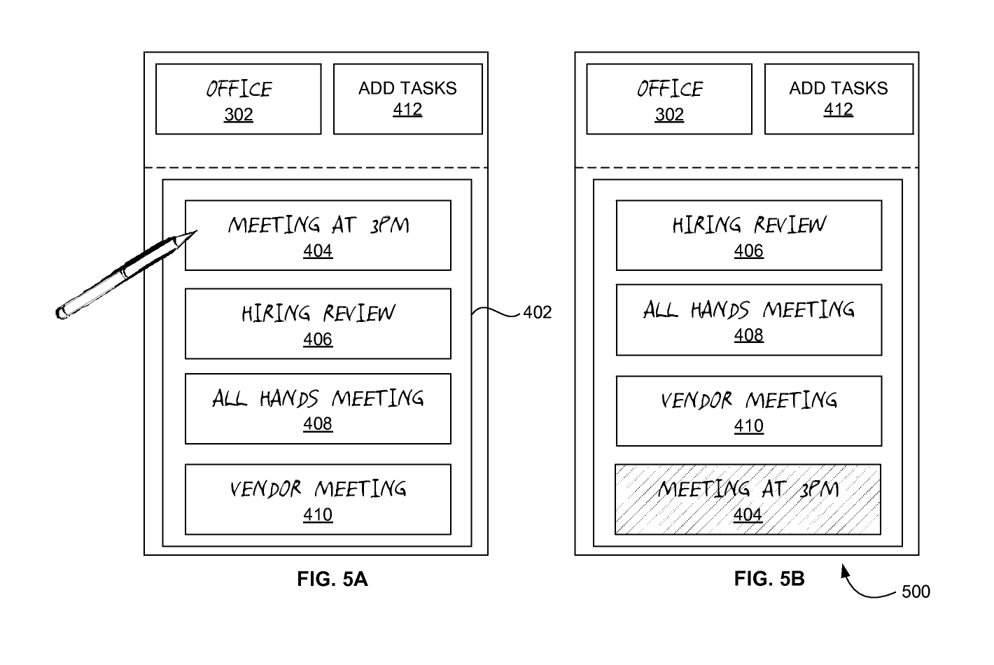

FIG. 5A and FIG. 5B illustrate a user interface view 500 of the status obtaining module 224 of the item management tool 106 of FIG. 1 according to one embodiment of the present disclosure. The status obtaining module 224 may process a handwritten input including an indication to strike an image associated with a task to obtain a status of the task. The status indicates whether the task is completed or still pending. For example, with reference to the FIG. 5A, when the user 102 has executed the first task ‘meeting at 3 PM’, the user 102 provides a handwritten input including an indication to strike the first image 404 that includes content ‘meeting at 3 PM’.

Once the user 102 provides the indication, with reference to the FIG. 5B, the first image 404 is placed in a manner such that images associated with tasks (e.g., hiring review, all hands meeting, and vendor meeting) that are yet to be completed are placed ahead of the first image 404. In one embodiment, the first image 404 which is indicated to strike is reordered to indicate a lower priority in the list 402. In another embodiment, the first image 404 which is indicated to strike is removed from the list 402. Also, the first image 404 may be provided with a representation (e.g., hatch lines) such that it is differentiated from the images of the tasks that are yet to be completed. Similarly, a status of the (a) second task “hiring review”, (b) the third task “all hands meeting”, and (c) the fourth task “vendor meeting” can be obtained.

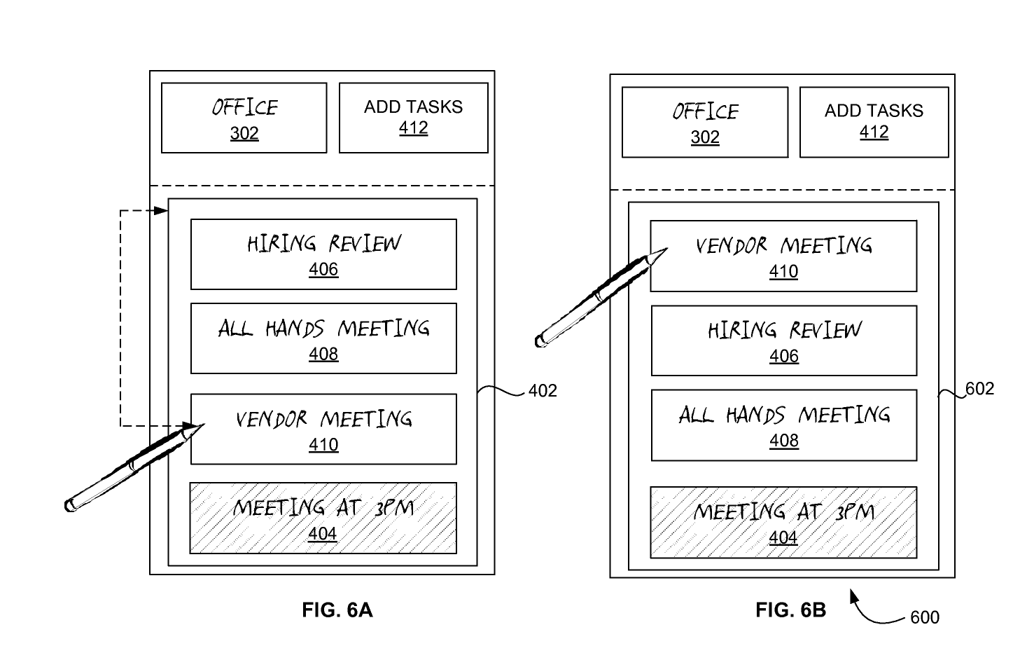

FIG. 6A and FIG. 6B illustrate a user interface view 600 of the prioritizing module 226 of the item management tool 106 of FIG. 1 according to one embodiment of the present disclosure. The prioritizing module 226 processes a handwritten input including an indication to drag and drop an image associated with a task to obtain a priority of the task. For example, with reference to FIG. 6A, when the user 102 intends to prioritize the fourth task ‘vendor meeting’ over other tasks of the list 402, the user 102 provides a handwritten input including an indication to drag the fourth image 410 associated with the fourth task ‘vendor meeting’, and drop the fourth image 410 on top of the list 402 as shown in the FIG. 6B. Similarly, the user 102 can provide an indication to drag and drop an image associated with a task in any order in any order to indicate the priority of the task.

Further, when the user 102 drag and drop the fourth image 410 includes content ‘vendor meeting’ as a high priority task, a priority associated with other tasks are automatically updated to obtain a list of prioritized images 602. The list of prioritized images 602 includes the second image 406 includes content ‘hiring review’ as a second high priority task, the third image 408 includes content ‘all hands meeting’ as a third high priority task, and the first image 404 includes content ‘meeting at 3 PM’ as a least priority task.

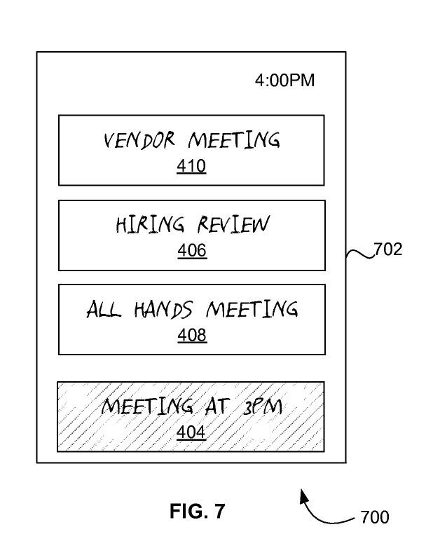

FIG. 7 illustrates a user interface view 700 of the alert generating module 214 of the item management tool 106 of FIG. 1 for generating alerts according to one embodiment of the present disclosure. The alert generating module 214 generates an alert based on a schedule (e.g., a time) associated with a task. An image associated with the task is displayed as an alert. For example, when the second task “hiring review” has scheduled to execute at 4.00 PM, the alert generating module 214 generates an alert 702 which includes the image “hiring review” as it was written based on a scheduled time of 4.00 PM. The alert can be generated exactly at 4.00 PM, or at a duration which is well before the scheduled time of 4.00 PM.

In one embodiment, the alert 702 includes images associated with other tasks, for example, “vendor meeting”, “all hands meeting”, and “meeting at 3 PM”, in addition to the image “hiring review” as shown in the FIG. 7. In another embodiment, the alert 702 includes only the image “hiring review”, and do not include images of other tasks. Similarly, an alert can be generated for a) the first task ‘meeting at 3 PM’, b) the third task ‘all hands meeting’, and c) the fourth task ‘vendor meeting’ based on a schedule (e.g., a time) associated with the corresponding task.

The character recognizing module 218 recognizes one or more numerals in the images of the list 402, and an alert is generated based on the one or more numerals. For example, from the first image 404 includes content “meeting at 3 PM, the character recognizing module 218 identifies a numeral “3 PM”. The alert generating module 214 then generates an alert for the first task “meeting at 3 PM” based on the numeral “3 PM”.

In one embodiment, the user 102 performs an action on an image associated with a task when the image is displayed at a time as an alert. The action may include editing content associated with the image, and/or snoozing the alert. The editing can be done based on a handwritten input as explained above using the updating module 216.

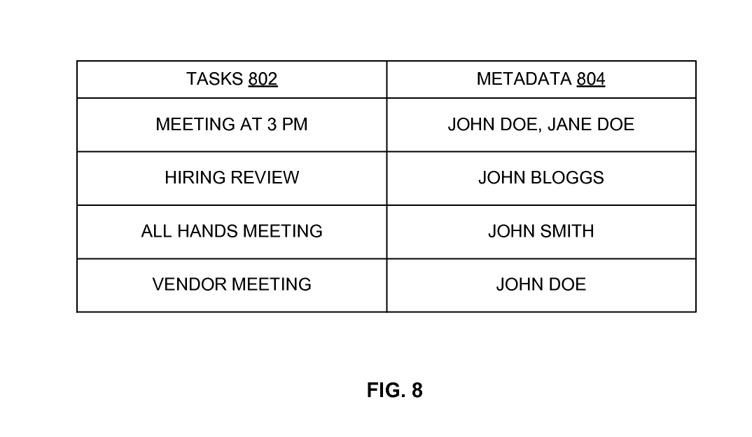

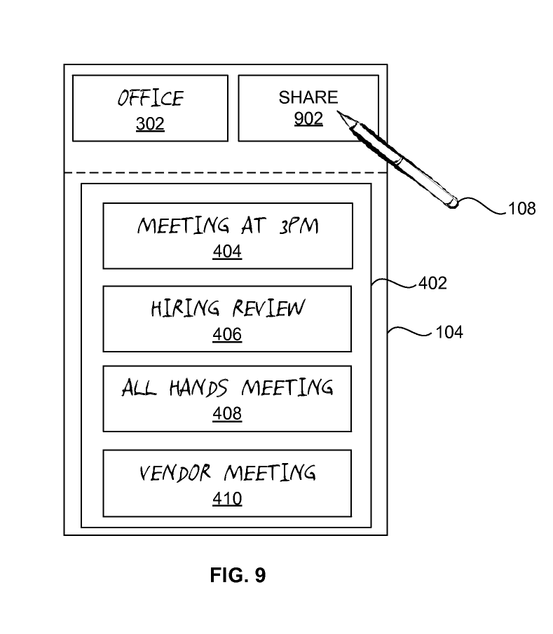

FIG. 8 is a table view illustrating tasks 802 associated with images of the list 402, and metadata 804 that correspond to each image of the list 402 according to one embodiment of the present disclosure. In one embodiment, the metadata 804 includes information about one or more person who is associated with the each image of the list 402. The information may include person's name, person's E-mail address, person's social profile ID, and the like. The item management tool 106 processes a handwritten input that may include a) selecting information (e.g., person's name) from a pre-stored data, or b) generating information (e.g., person's name) associated with a task when an image associated with the task is generated. The metadata 804 associated with each image that corresponds to each task is stored in the database 202. For example, for a task “meeting at 3 PM”, a metadata that may include information such as person's name who are required for the task may be “John Doe”, and “Jane Doe”. For a task “hiring review”, a required person may be “John Bloggs”. For a task “All hands meeting”, a required person may be “John Smith”, and for a task “vendor meeting”, a required person may be “John Doe”.

With respect to FIG. 8, FIG. 9 is a user interface view illustrates sharing the list 402 based on metadata associated with one or more images of the list 402 according to one embodiment of the present disclosure. In one embodiment, when the user 102 selects a share field 902, the image filtering module 221 filters one or more images of the list 402 based on metadata that includes information about one or more person who is associated with at least one image of the list 402, and generates one or more list of filtered images.

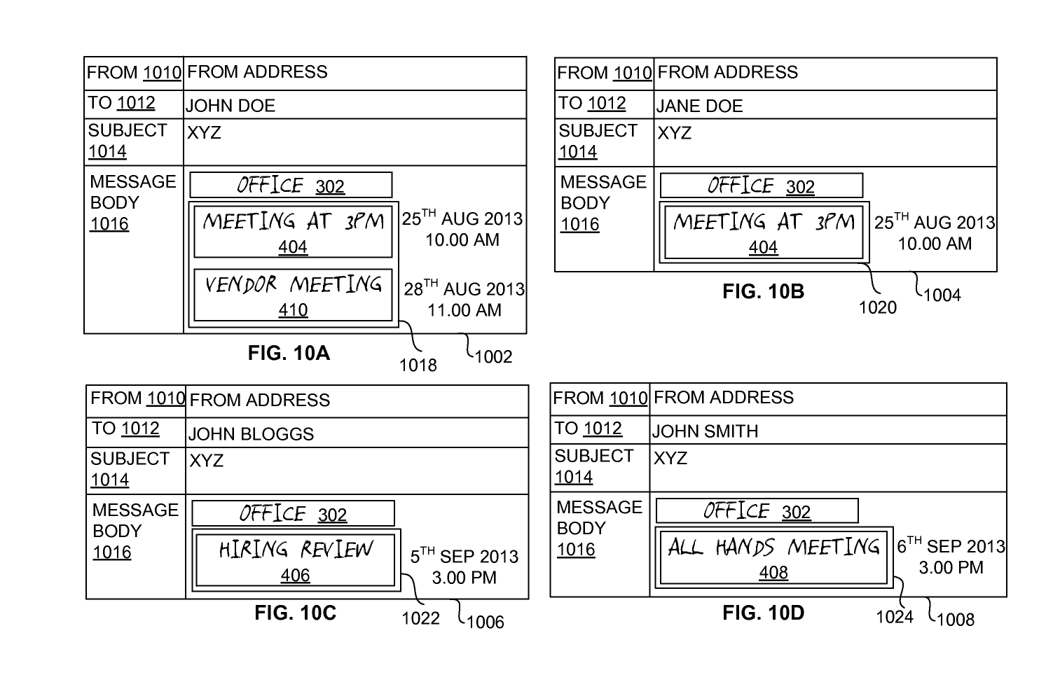

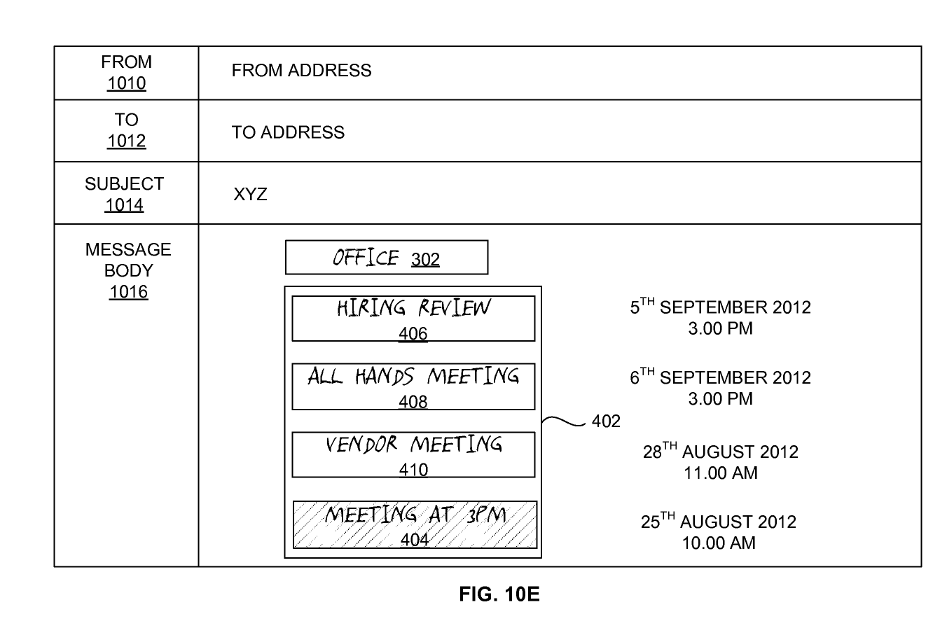

With reference to FIG. 8 and FIG. 9, FIG. 10A-D is user interface view that are displayed to one or more person when the user 102 provides a handwritten input to select the share field 902 for sharing the list 402 through a medium of electronic mail according to one embodiment of the present disclosure. On selection of the share field 902, as shown in the embodiment of FIG. 9, one or more electronic mail is generated. For example, a first electronic mail 1002, a second electronic mail 1004, a third electronic mail 1006, and a fourth electronic mail 1008 are generated based on the metadata 804 associated with images of the tasks 802. The user interface view includes a from field 1010, a to field 1012, a subject field 1014, and a message body field 1016.

Based on the metadata ‘John Doe’ that corresponds to the tasks ‘meeting at 3 PM’, and ‘vendor meeting’, a first list of filtered images 1018 is obtained. The first list of filtered images includes images ‘meeting at 3 PM’, and ‘vendor meeting’ as it was written as handwritten inputs, and may be displayed at the message body 1016 of the first electronic mail 1002. Based on the metadata ‘Jane Doe’ that corresponds to the task ‘meeting at 3 PM’, a second list of filtered image 1020 which includes an image ‘meeting at 3 PM’ as it was written as an handwritten input is obtained. The second list of filtered image 1020 may be displayed at the message body 1016 of the second electronic mail 1004. Similarly, the third electronic mail 1006 which includes a third list of filtered image 1022, and the fourth electronic mail 1008 which includes a fourth list of filtered image 1024 is generated, and communicated to corresponding person based on the metadata. For each image which is displayed at the message body 1016 of an electronic mail, corresponding metadata (e.g., a schedule, a status, etc) may also be displayed at the message body 1016. Alternatively, a list of filtered image may also be communicated as an attachment of an electronic mail.

Alternatively, the user 102 can share a selected image of the list 402 based on a metadata associated with the image. For example, when the user 102 indicates to share the image ‘meeting at 3 PM’, the image filtering module 221 may filter the image ‘meeting at 3 PM’ from the list 402. An electronic mail is generated automatically with the image ‘meeting at 3 PM’ optionally with corresponding metadata (e.g., status), and communicated to the person ‘John Doe’ and ‘Jane Doe’. In one embodiment, using the item management tool 106, the user 102 may filter one or more images from the list 402, and communicates a list of filtered images to other persons who are not associated with tasks of the list 402.

FIG. 10E illustrates a user interface view that is displayed to the one or more users while communicating the list 402 through an electronic mail according to one embodiment of the present disclosure. The list 402 may include images associated with one or more tasks that are completed, and/or images associated with one or more tasks that are yet to be completed. The user interface view includes a from field 1010, a to field 1012, a subject field 1014, and a message body field 1016. When the user 102 shares the list 402 through an electronic mail, images of the list 402 may be displayed to the one or more users (e.g., one or person who are associated with the task, and/or one or more person who are not associated with the task). Further, a scheduled time associated with each image may be displayed as shown in the FIG. 10E.

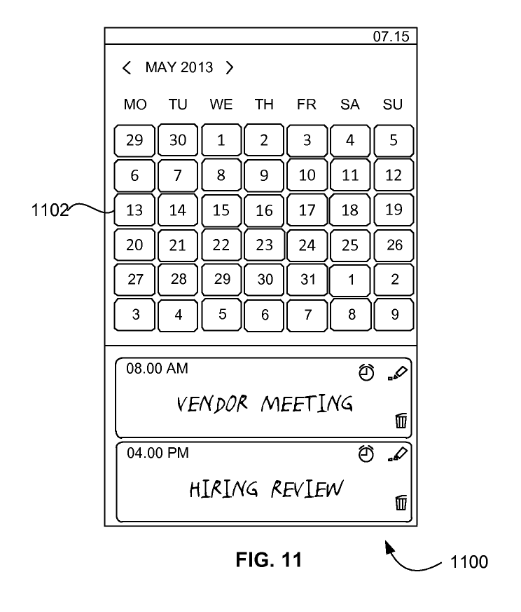

FIG. 11 is a user interface view 1100 that illustrates generating images associated with one or more tasks that have scheduled for a duration based on a selection of the duration from an electronic calendar 1102 according to one embodiment of the present disclosure. For instance, the task “vendor meeting” has scheduled for May 20, 2013 at 8.00 AM, and the task “hiring review” has scheduled for the same day at 4.00 PM. When the user 102 selects a duration (e.g., May 20, 2013) from the electronic calendar 1102, the corresponding images “vendor meeting” and “hiring review” are generated, and displayed to the user 102. Similarly, the user 102 can select any particular duration from the electronic calendar 1102 to generate images associated with set of tasks that have scheduled for that particular duration.

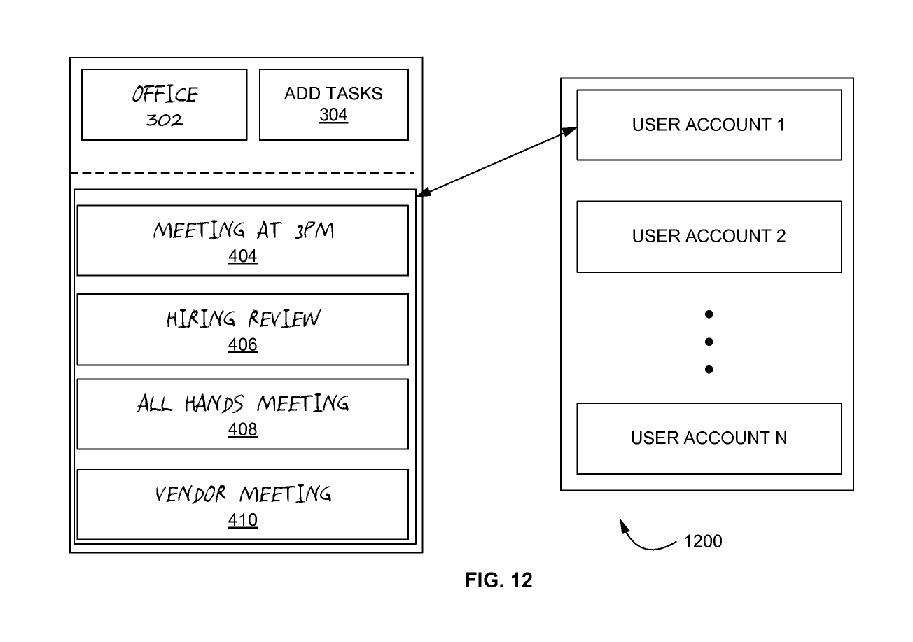

FIG. 12 illustrates a process view 1200 of using the item management tool 106 of FIG. 1 for creating back-up and synchronizing one or more tasks of the first category “office” 302 on the item management server 112 of FIG. 1 according to an embodiment herein. The item management server 112 stores handwritten tasks and their associated metadata created by the user 102. The tasks and associated metadata created by the user 102 are stored in a user account created by the user 102 on the item management server 112. The synchronization module 116 automatically synchronizes the user account 1 of a first user and creates a back-up of all user data at regular intervals based on an application status. The first category “office” 302 with a list of tasks associated is stored on the item management server 112. The user account 1 is synchronized at regular intervals and back-up is taken if any changes are made by the user 102 according to status of tasks associated with the first category “office” 302.

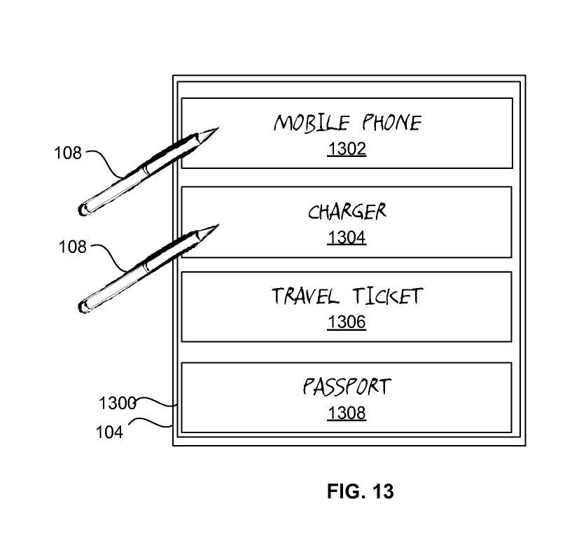

FIG. 13 illustrates an example of a list of items (a checklist 1300) that includes one or more images associated with items for planning or organizing the items based on handwritten input according to one embodiment of the present disclosure. As described in the previous embodiments, the handwritten input processing unit processes handwritten inputs that include content associated with generating items. The image generating module 205 generates images that include the content associated with the items as it was written, and the checklist 1300 is generated and displayed at the touch sensitive display interface of the user device 104. Examples of such images include ‘mobile phone’ 1302, ‘charger’ 1304, ‘travel ticket’ 1306, and ‘passport’ 1308.

Metadata (e.g., priority) associated with each image of the checklist 1300 may be obtained, and the checklist 1300 may be shared to one or more users as described in the previous embodiments. Each image and corresponding metadata of the checklist 1300 may be stored in the database 202. One or more images of the checklist 1300 may be filtered to obtain a list of filtered images based on metadata associated with at least one image of the checklist 1300. The images of the checklist 1300 may also be prioritized based on priority associated with items of the checklist 1300 based on a handwritten input.

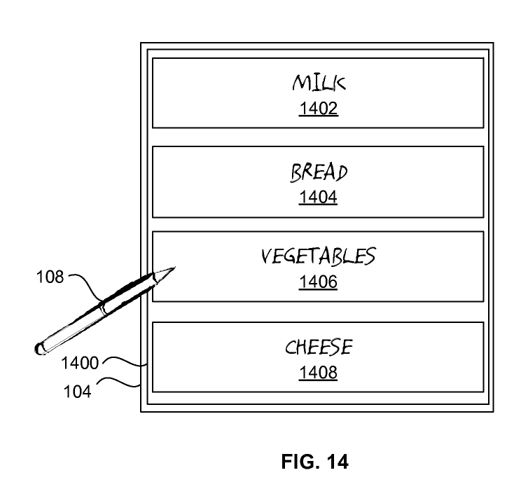

FIG. 14 illustrates an another example of a list of items (a shopping list 1400) that includes one or more images associated with items for planning or organizing the items based on handwritten input according to one embodiment of the present disclosure. Examples of images associated with the shopping list 1400 include ‘milk’ 1402, ‘bread’ 1404, ‘vegetables’ 1406, and ‘cheese’ 1408. Each image and corresponding metadata (e.g., status, an image that corresponds to an item in the shopping list 1400 may be indicated to strike when the item is purchased) of the shopping list 1400 is stored in the database. It is to be understood that a list of items is not restricted to a list of tasks, a checklist, a shopping list, a person name list, etc. The embodiments described herein can be extended to any type of lists.

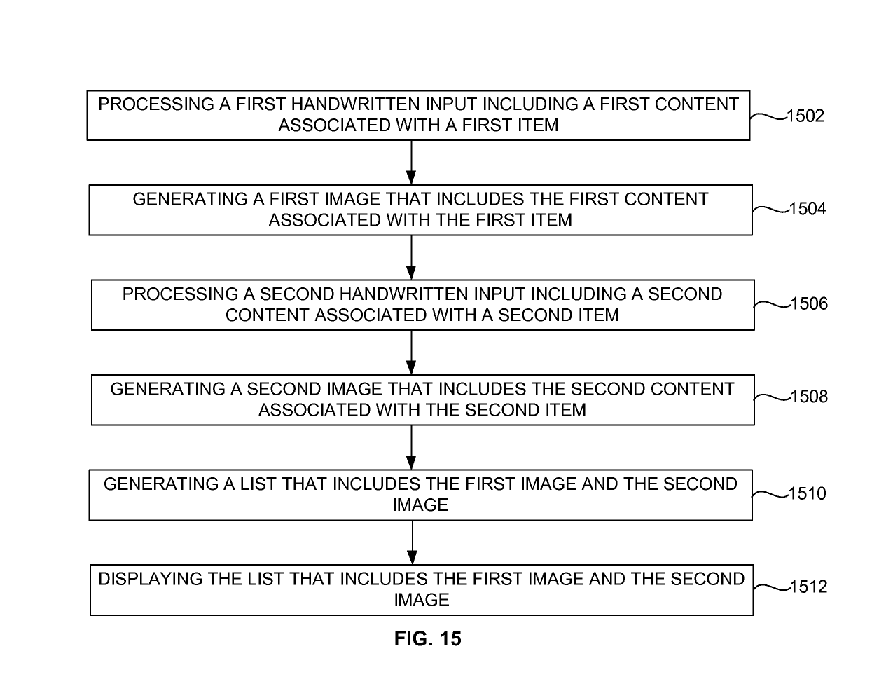

FIG. 15 is a flow diagram illustrating a method for generating a list of images associated with items for planning or organizing the items on the user device 104 which is configured for receiving handwritten inputs according to one embodiment of the present disclosure. In step 1502, processing, by a processor, a first handwritten input including a first content associated with a first item. In step 1504, generating, by the processor, a first image that includes the first content associated with the first item. In step 1506, processing, by the processor, a second handwritten input including a second content associated with a second item. In step 1508, generating, by the processor, a second image that includes the second content associated with the second item. In step 1510, generating, by the processor, a list that includes the first image and the second image. The first image and the second image are stored in a database. In step 1512, displaying the list that includes the first image, and the second image.

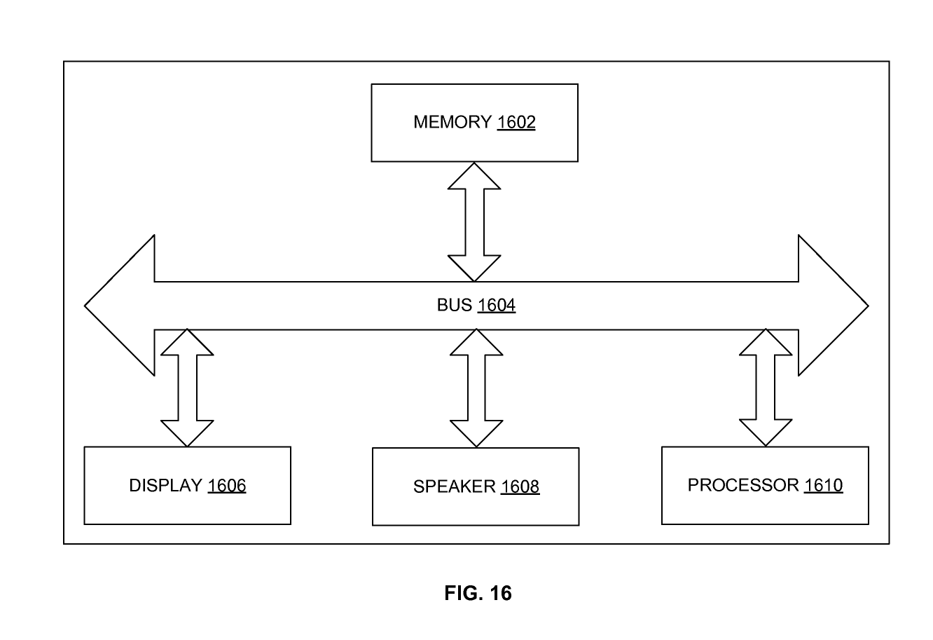

FIG. 16 illustrates an exploded view of a receiver of having an a memory 1602 having a set of computer instructions, a bus 1604, a display 1606, a speaker 1608, and a processor 1610 capable of processing a set of instructions to perform any one or more of the methodologies herein, according to an embodiment herein. The processor 1610 may also enable digital content to be consumed in the form of video for output via one or more displays 1606 or audio for output via speaker and/or earphones 1608. The processor 1610 may also carry out the methods described herein and in accordance with the embodiments herein.

Digital content may also be stored in the memory 1602 for future processing or consumption. The memory 1602 may also store program specific information and/or service information (PSI/SI), including information about digital content (e.g., the detected information bits) available in the future or stored from the past. A user of the receiver may view this stored information on display 1606 and select an item of for viewing, listening, or other uses via input, which may take the form of keypad, scroll, or other input device(s) or combinations thereof. When digital content is selected, the processor 1610 may pass information. The content and PSI/SI may be passed among functions within the receiver using the bus 1604.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections).

In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

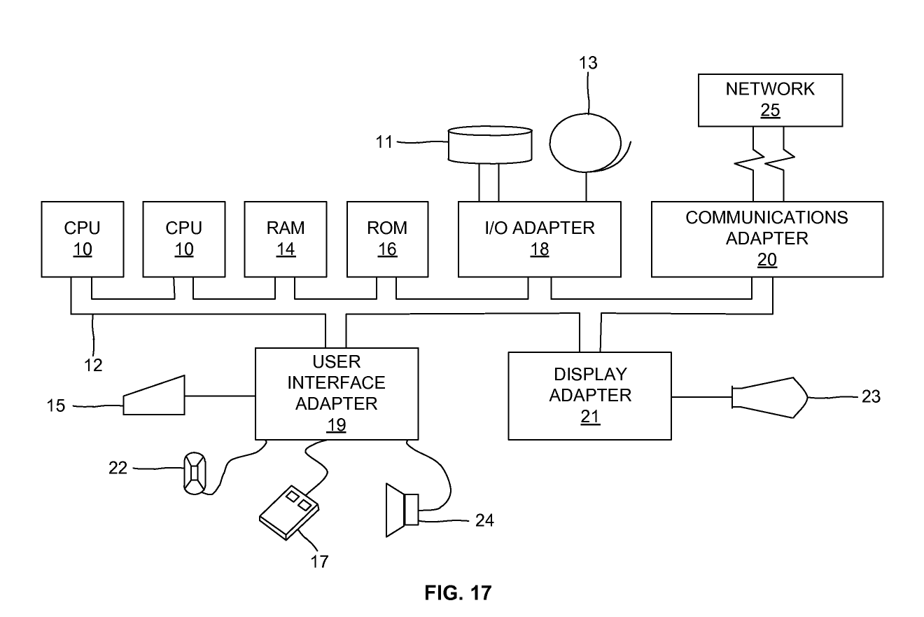

A representative hardware environment for practicing the embodiments herein is depicted in FIG. 17. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The item management tool 106 allows creating a back-up of all the handwritten tasks. Further, synchronize the updated data and associated metadata on the item management server 112 periodically. The one or more tasks and task category can be shared with one or more user accounts. Further, combines the power of writing on a notepad with the enhancements possible because the data is stored in the digital format—e.g. communicating through email or any content communicating services.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

1. A method for generating a list of images associated with items for planning or organizing the items on a device configured for receiving handwritten input, the method comprising:
(i) processing, by a handwritten input processing unit, a first handwritten input comprising a first content associated with a first item;
(ii) generating, by a processor, a first image that comprises the first content associated with the first item;
(iii) processing, by the handwritten input processing unit, a second handwritten input comprising a second content associated with a second item;
(iv) generating, by the processor, a second image that comprises the second content associated with the second item;
(v) generating, by the processor, a list that comprises the first image and the second image, wherein the first image and the second image are stored in a database; and
(vi) displaying the list that comprises the first image and the second image.

2. The method of claim 1, further comprising: processing (a) a third handwritten input to obtain a metadata associated with the first image that corresponds to the first item, and (b) a fourth handwritten input to obtain a metadata associated with the second image that corresponds to the second item of the list, wherein the metadata comprises at least one of (a) a schedule, (b) a status, (c) a priority, and (d) a category.

3. The method of claim 2, further comprising generating a list of prioritized images by (a) processing the third handwritten input that comprises an indication to drag and drop the first image associated with the first item to a position at the list, or (b) by processing the fourth handwritten input that comprises an indication to drag and drop the second image associated with the second item to a position at the list.

4. The method of claim 2, further comprising (a) processing the third handwritten input comprises an indication to strike the first image associated with the first item to remove the first image from the list or reorder the first image to indicate a low priority in the list, or (b) processing the fourth handwritten input comprises an indication to strike the second image associated with the second item from the list to remove the second image from the list or reorder the second image to indicate a low priority in the list.

5. The method of claim 2, further comprising (i) displaying (a) the first image, or (b) the list based on a schedule associated with the first item as a first alert, and (ii) displaying (a) a second image, or (b) the list based on a schedule associated with the second item as a second alert, wherein at least one of (a) the first image, or (b) the second image is updated based on a handwritten input when the first alert or the second alert is displayed.

6. The method of claim 1, further comprising filtering images of the list based on metadata associated with at least one image of the list to obtain a list of filtered images.

7. The method of claim 6, further comprising communicating (i) the list of filtered images, and (ii) a metadata associated with at least one image of the list of filtered images through a medium comprising an electronic mail, wherein (i) the list of filtered images, and (ii) the metadata are displayed on a message body of the electronic mail.

8. The method of claim 1, further comprising
(i) processing a fifth handwritten input comprising at least one of:
(a) additional content associated with (i) the first content that corresponds to the first image, or (ii) the second content that corresponds to the second image, and
(b) an indication to remove a subset of content from (i) the first image, or (ii) the second image, and
(ii) updating the first image or the second image based on at least one of (a) the additional content, and (b) the indication.

9. The method of claim 1, further comprising
(i) processing a selection of a duration from an electronic calendar of the device;
(ii) generating images associated with a set of items that has scheduled to execute at the duration; and
(iii) displaying the images associated with the set of items.

10. A system for generating a list of images associated with items for planning or organizing the items on a device configured for receiving handwritten input, the system comprising:
(a) a memory unit that stores (i) a set of modules, and (ii) a database;
(b) a display unit;
(c) a handwritten input processing unit that processes handwritten inputs comprising at least one of (i) a touch on the display unit, and (ii) a gesture, wherein the handwritten inputs associate with a) a first content associated with a first item, and b) a second content associated with a second item; and
(d) a processor that executes the set of modules, wherein the set of modules comprise:
(i) a list generating module comprising: (a) an image generating module, executed by the processor, that generates (i) a first image that comprises the first content associated with the first item, and (ii) a second image that comprises the second content associated with the second item, wherein the list generating module, executed by the processor, that generates a list that comprises the first image and the second image; and
(ii) a display module, executed by the processor that displays at the display unit the list comprising the first image and the second image, wherein the first image that corresponds to the first item and the second image that corresponds to the second item of the list are stored in the database.

11. The system of claim 10, wherein the set of modules further comprise a metadata module, executed by the processor, that processes (a) a third handwritten input to obtain a metadata associated with the first image that corresponds to the first item, and (b) a fourth handwritten input to obtain a metadata associated with the second image that corresponds to the second item of the list, wherein the metadata comprises at least one of (a) a schedule, (b) a status, (c) a priority, and (d) a category.

12. The system of claim 11, wherein the metadata module comprises a prioritizing module, executed by the processor, that generates a list of prioritized images by (a) processing the third handwritten input that comprises an indication to drag and drop the first image associated with the first item to a position at the list, or (b) by processing the fourth handwritten input that comprises an indication to drag and drop the second image associated with the second item to a position at the list.

13. The system of claim 11, wherein the metadata module further comprises a status obtaining module, executed by the processor, that (a) processes the third handwritten input comprises an indication to strike the first image associated with the first item to remove the first image from the list or reorder the first image to indicate a low priority in the list, or (b) processes the fourth handwritten input comprises an indication to strike the second image associated with the second item from the list to remove the second image from the list or reorder the second image to indicate a low priority in the list.

14. The system of claim 11, wherein the metadata module further comprises a categorizing module, executed by the processor that processes a fifth handwritten input comprising content to generate a category, wherein a third image that corresponds to a third item is associated with the category.

15. The system of claim 10, wherein the set of modules further comprise an alert generating module executed by the processor that (i) displays (a) the first image, or (b) the list based on a schedule associated with the first item as a first alert, and (ii) displays (a) a second image, or (b) the list based on a schedule associated with the second item as a second alert, wherein at least one of (a) the first image, or (b) the second image is updated based on a handwritten input when the first alert or the second alert is displayed.

16. The system of claim 10, wherein the set of modules further comprise an image filtering module, executed by the processor, that filters images of the list based on metadata associated with at least one image of the list to obtain a list of filtered images.

17. The system of claim 16, wherein the set of modules further comprise a communicating module, executed by the processor, that communicates (i) the list of filtered images, and (ii) a metadata associated with at least one image of the list of filtered images through a medium comprising an electronic mail, wherein (i) the list of filtered images, and (ii) the metadata are displayed on a message body of the electronic mail.

18. The system of claim 10, wherein the set of modules further comprise a character recognizing module, executed by the processor, that
(a) recognizes a numeral in (i) the first image, or (ii) the second image; and
(b) generates (a) a call, or (b) a message to a communication device associated with the numeral.

19. A device for generating a list of filtered images associated with items for planning or organizing the items on a device configured for receiving handwritten input, the device comprising:
(a) a memory unit that stores (i) a set of modules, and (ii) a database;
(b) a display unit;
(c) a handwritten input processing unit that processes handwritten inputs comprising at least one of (i) a touch on the display unit, and (ii) a gesture, wherein the handwritten inputs associate with a) a first content associated with a first item, and b) a second content associated with a second item; and
(d) a processor that executes the set of modules, wherein the set of modules comprises:
(i) a list generating module comprising:
(a) an image generating module, executed by the processor, that generates (i) a first image that comprises the first content associated with the first item, and (ii) a second image that comprises the second content associated with the second item, wherein the list generating module, executed by the processor, that generates a list that comprises the first image and the second image;
(ii) a display module, executed by the processor that displays at the display unit the list comprising the first image and the second image, wherein the first image that corresponds to the first item and the second image that corresponds to the second item of the list are stored in the database; and
(iii) an image filtering module, executed by the processor, that filters images of the list based on metadata associated with at least one image of the list to obtain a list of filtered images.

20. The device of claim 19, wherein the set of modules further comprise a communicating module, executed by the processor, that communicates (i) the list of filtered images, and (ii) a metadata associated with at least one image of the list of filtered images through a medium comprising an electronic mail, wherein (i) the list of filtered images, and (ii) the metadata are displayed on a message body of the electronic mail.
